(19) United States
(12) Patent Application Publication
(10) Pub. No.: US 2010/0084875 A1
(43) Pub. Date: Apr. 8, 2010

(54) MAGNETIC LOCK FOR WINDOWS

(75) Inventors: Garth C. Keighley, Reno, NV (US); Mathew D. Ruspil, Reno, NV (US)

Correspondence Address: LAW OFFICE OF DELIO & PETERSON, LLC., 121 WHITNEY AVENUE, 3RD FLLOR, NEW HAVEN, CT, 06510, US

(73) Assignee: INTERLOCK USA, INC., Reno, NV (US)

(21) Appl. No.: 12/245,761

(22) Filed: Oct. 5, 2008

(51) Int. Cl. E05C 19/16; E05C 1/08; E05B 63/24

(52) U.S. Cl. 292/152; 292/251.5; 292/332

(57) ABSTRACT

The invention relates to a lock for a window having a button and a spring for biasing the button to move from an unlocked position to a locked position; a spring clip in contact with the button for holding the button in the unlocked position; a trigger for engaging with the spring clip to release the button and allow the spring to move the button toward the locked position; a hook for moving from an unlocked position to a locked position in correspondence with the button moving from the unlocked position to the locked position; and a rotatable arm with one end attached to the button and another end attached to the hook, the rotatable arm for transmitting a movement of the button to a movement of the hook. A magnet is attached to the trigger and the magnet is moved, which in turn actuates the trigger, by a polarity of another magnet.

### FIELD OF THE INVENTION

The invention relates to a lock mechanism for a window.

### BACKGROUND OF THE INVENTION

A double-hung, single hung, and double slider window assembly typically includes a window frame and a pair of window sashes mounted for vertical reciprocal sliding movement, one relative to the other, in guide rails of the master frame jamb of the window assembly.

A traditional lock for a double hung window usually involves a part of the lock on one sash and the other part of the lock on the other sash, wherein joining the two parts of the lock together results in locking the sashes to one another.

One disadvantage of this type of lock is that it normally requires the sashes be a certain distance away from one another, wherein the sashes being too close or too far apart may render the lock ineffective. For example, if the sashes are spaced too far apart, the two parts of the lock may not be able to be joined together and the window may not lock. If the sashes are too close together, the parts of the lock may bind or interfere with one another, resulting in the parts not being able to mate together and therefore the window may not be locked. These problems may occur during installation where the installer must adjust the window sashes and lock, perhaps numerous times, before achieving a proper fit between the sashes and lock. These problems may also occur over time when windows become old, warped, or damaged through normal wear.

As a result of the foregoing disadvantage, the lock and/or window may need to be replaced without any assurance that the problems will not reoccur. In addition, forcibly pushing the sashes together in order to bring them to a proper distance may result in stress upon the frame around the sashes and/or the glass panes. Continuing to use the lock and window in this fashion can exacerbate the problems.

What is desired, therefore, is a lock that is more flexible to use than a traditional lock. Another desire is a lock that accommodates changes in the spacing between the sashes. A further desire is a lock that is more resistant to damage than a traditional lock without sacrificing reliability. Yet another desire is a lock that works for sashes that have a varying distance between them. Another desire is a lock that automatically locks a window without physical interaction with the strike or window in order to change states; from unlocked to locked positions. A further desire is a lock with multiple drive options to be utilized based off of an application type and furniture design. It is also desirable to provide a lock indicator for indicating whether or not the lock is locked or unlocked.

### SUMMARY OF THE INVENTION

Bearing in mind the problems and deficiencies of the prior art, it is therefore an object of the present invention to provide a lock that accommodates variations in the spacing between the sashes.

It is another object of the present invention to provide a lock that automatically secures the window without physical interaction with the strike or window in order for the lock to move from an unlocked position to a locked position.

A further object of the invention is to provide a lock that overcomes the disadvantages of a traditional lock stated above.

Still other objects and advantages of the invention will in part be obvious and will in part be apparent from the specification.

Yet another object is a lock that provides an indicator for indicating whether or not the lock is in an unlocked or locked position.

The above and other objects, which will be apparent to those skilled in the art, are achieved in the present invention which is directed to a lock for a window having a button and a spring for biasing the button to move from an unlocked position to a locked position; a spring clip in contact with the button for holding the button in the unlocked position; a trigger for engaging with the spring clip to release the button and allow the spring to move the button toward the locked position; a hook for moving from an unlocked position to a locked position in correspondence with the button moving from the unlocked position to the locked position; and an arm with one end attached to the button and another end attached to the hook, the arm for transmitting a movement of the button to a movement of the hook.

In some embodiments, the trigger includes a second spring to move the trigger from a locked position to an unlocked position, the second spring being separate from the spring.

In another embodiment, a magnet is in contact with the trigger for actuating the trigger to engage with the spring clip.

In a further embodiment, a housing is in communication with the hook, the housing including a channel and the hook including a post being placed within the channel for guiding a movement of the hook.

In yet another embodiment, a strike magnet is in communication with the magnet for moving the magnet when the strike magnet is placed proximate to the magnet.

In other embodiments, the trigger includes a first protrusion and a second protrusion, wherein the first protrusion is positioned proximate to the spring clip for engaging with the spring clip to release the button. The second protrusion extends from a surface of the trigger in a different direction than a direction of the first protrusion.

In some embodiments, a lug is attached to trigger for positioning the first protrusion so that the first protrusion is proximate the spring clip for engaging the spring clip.

In another embodiment, the arm translates a generally linear movement of the trigger to a movement of the hook.

As shown, movement of the trigger from the locked position to the unlocked position is independent of a movement of the button, and the movement of he button from the locked to the unlocked positions is independent from the movement of the button. However, movement of the trigger from the unlocked position to the locked position actuates a movement of the button from the unlocked position to the locked position.

In another aspect of the invention, a method of providing a lock includes the steps of holding a button in an unlocked position; placing a spring adjacent to the button for biasing the button toward a locked position; connecting the button to a hook for locking a window when the button is biased from the unlocked position to the locked position; and placing an arm between the hook and the button to transmit movement from the button to movement to the hook.

In another embodiment, the method holds the button in the unlocked position with a spring clip. In some of these embodiments, a trigger is placed proximate to the button for engaging the spring clip, which releases the hold on the button and allows the spring to bias the button toward the locked position.

In a further embodiment, the method includes the steps of placing a magnet proximate the trigger for actuating the trigger to engage with the spring clip; and placing a strike magnet proximate to the magnet for moving the magnet and actuating the trigger.

In some embodiments, the method translates a generally linear movement of the trigger to a movement of the hook.

In other embodiments, the method attaches a second spring to the trigger for biasing the trigger toward the unlocked position. In some of these embodiments, the method includes the step of moving the button from the locked position to the unlocked position independently from the step of biasing the trigger from the locked position to the unlocked position.

In yet another embodiment, the method biases the trigger to the unlocked position without engaging the spring clip.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the lock in accordance with the invention.

FIG. 2 more particularly depicts the lock shown in FIG. 1.

FIG. 3 depicts the inside of the lock shown in FIG. 1.

FIG. 4 depicts an assembly view of the lock shown in FIG. 1.

FIG. 5 depicts a top view of the lock shown in FIG. 1 in a locked position.

FIG. 6 depicts a top view of the lock shown in FIG. 1 in an unlocked position.

FIG. 7 depicts a top view of the lock with strike shown in FIG. 1 in a locked position.

FIG. 8 depicts a more detailed top view of the lock shown in FIG. 1 in a locked position.

FIG. 9 more particularly depicts the engagement of the spring clip, button, and trigger shown in FIG. 1.

FIG. 10 more particularly depicts the trigger shown in FIG. 1.

FIG. 11 is a cross sectional view of the lock taken across line 11-11 shown in FIG, 5.

FIG. 12 is a cross sectional view of the lock taken across line 12-12 shown in FIG. 5.

FIG. 13 depicts a method for providing the lock shown in FIG. 1.

FIG. 14 depicts the lock shown in FIG. 1 using a strike magnet that attracts the magnet in the housing.

FIG. 15 depicts a detailed top view of the lock shown in FIG. 1 using a strike magnet that attracts the magnet in the housing.

FIG. 16 depicts the engagement of the button, spring clip, and trigger shown in FIG. 1 using a strike magnet that attracts the magnet in the housing.

FIG. 17 more particularly depicts the trigger shown in FIG. 1 using a strike magnet that attracts the magnet in the housing.

FIG. 18 depicts another detailed view of the inside of the lock shown in FIG. 1.

FIG. 19 depicts push plate 18 shown in FIG. 1 being used as an indicator for indicating whether or not the lock shown in FIG. 1 is locked or unlocked.

### DETAILED DESCRIPTION OF THE DRAWINGS

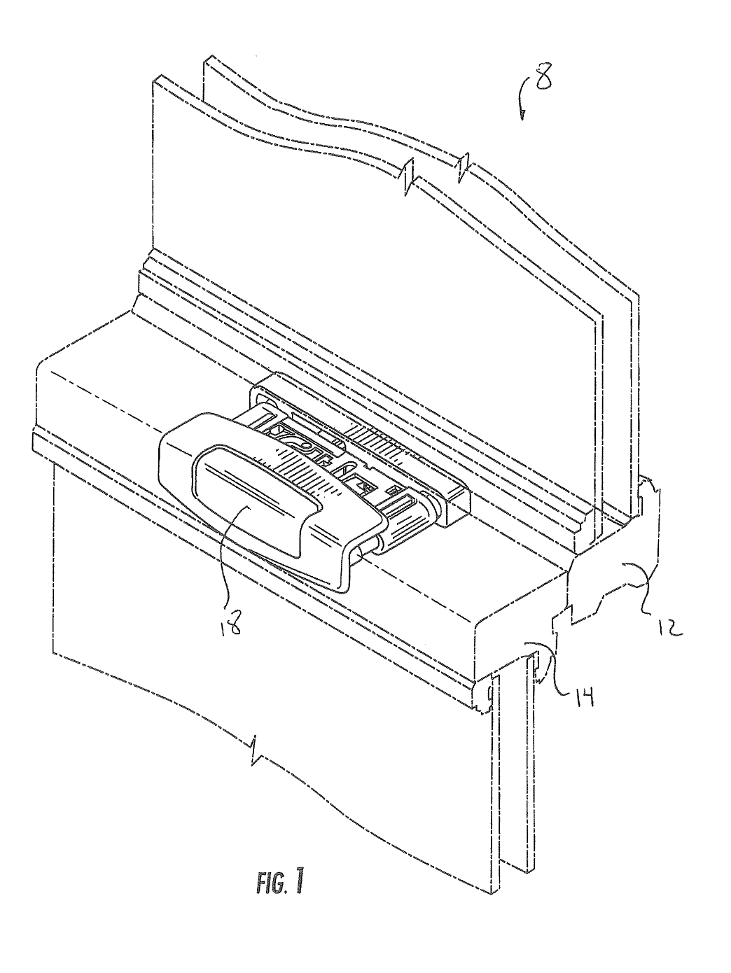

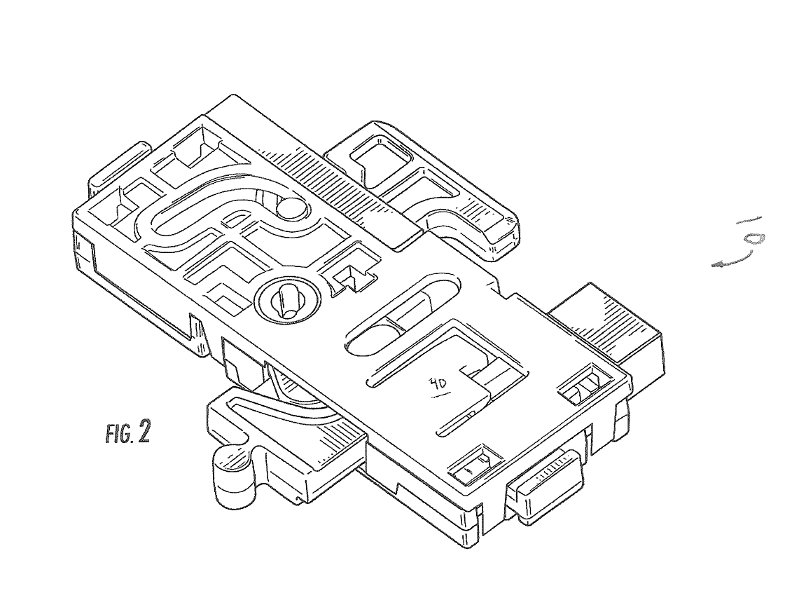

In describing the preferred embodiment of the present invention, reference will be made herein to FIGS. 1-13 of the drawings in which like numerals refer to like features of the invention.

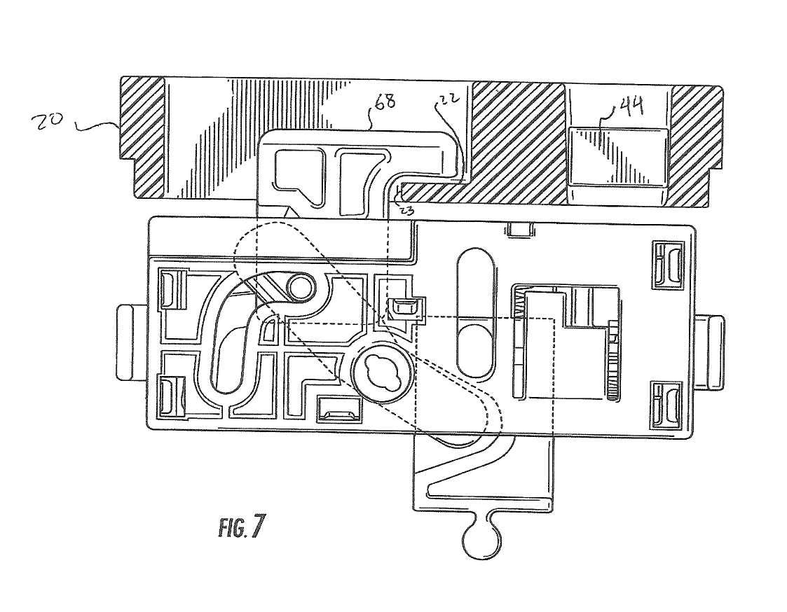

FIGS. 1 and 7 depict lock 10 in accordance with the invention, where lock 10 secures sashes 12, 14 together, resulting in window 8 being locked. As shown, strike 20 and strike magnet 44 are placed on or within sash 12 and the remaining components of lock 10 are placed on or within sash 14, wherein hook 68 mates with or contacts shoulder 22 of strike 20 to secure sashes 12, 14 together.

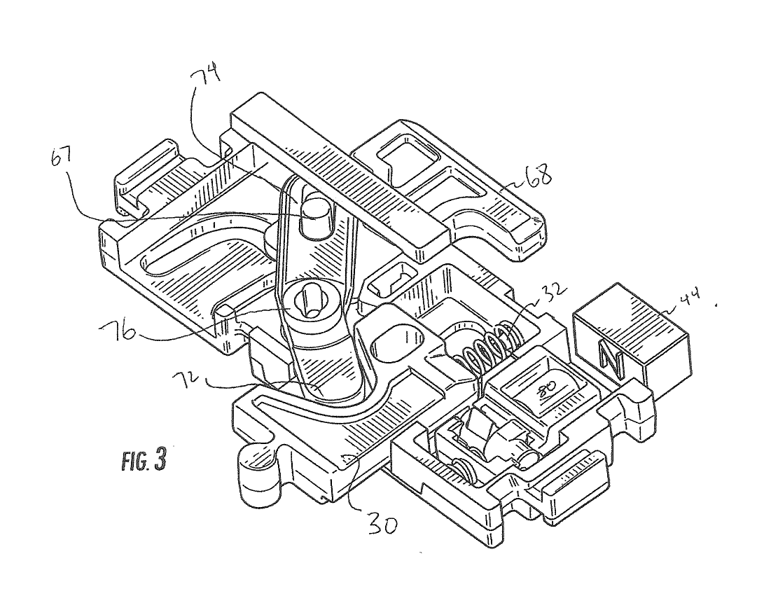

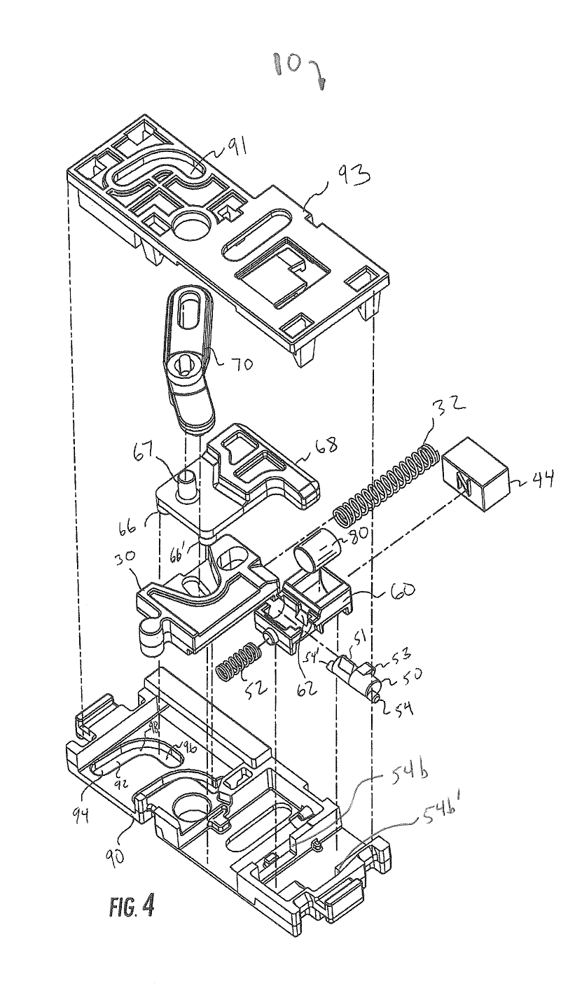

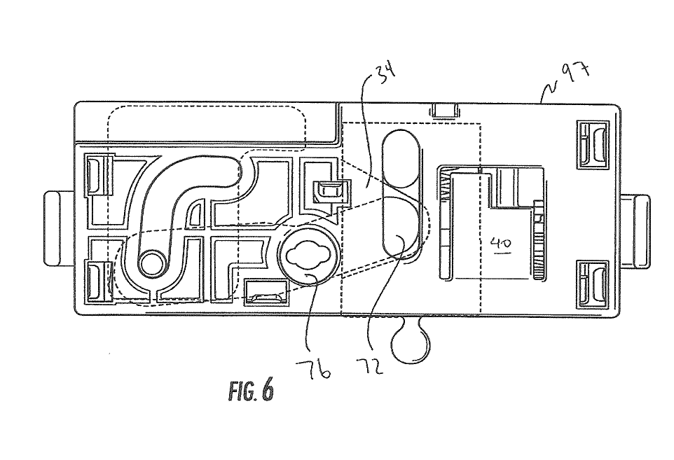

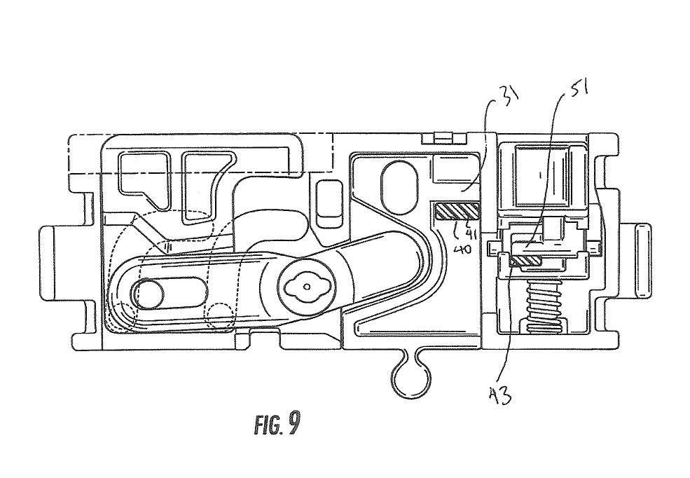

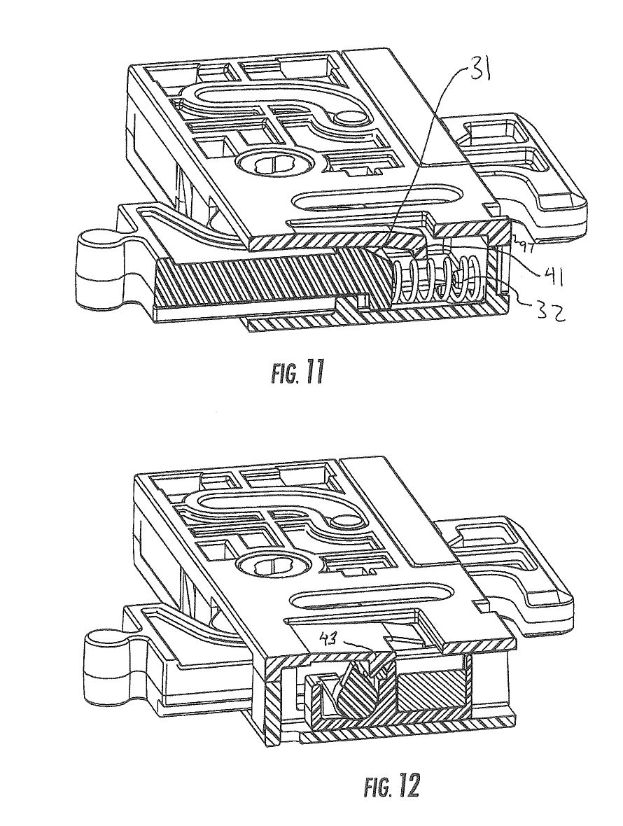

As shown more particularly in FIGS. 3-4, lock 10 includes button 30 and spring 32 attached to button 30 for biasing button 30 to move from an unlocked position (FIG. 6) to a locked position (FIG. 7), spring clip 40 (specifically spring clip flange 41) in contact with button 30 (specifically button flange 31) for holding button 30 in the unlocked position (see FIGS. 9 and 11), and trigger 50 (specifically first protrusion 51) for engaging with spring clip 40 (specifically second spring clip flange 43) to release button 30 and allow spring 32 to move button 30 toward the locked position (see FIGS. 9 and 11).

Lock 10 also includes hook 68 for moving from an unlocked position to a locked position in correspondence with button 30 moving from the unlocked position to the locked position, and arm 70 with one end 72 attached to button 30 and another end 74 attached to hook 68, wherein arm 70 transmits a movement of button 30 to a movement of hook 68. In some embodiments, arm 70 is rotatable.

In another embodiment, trigger 50 includes second spring 52 to move trigger 50 from a locked position to an unlocked position, where second spring 52 is separate and independent from spring 32.

As shown in FIGS. 3-4, lock 10 further comprises magnet 80 in contact with trigger 50 for actuating trigger 50 to engage with spring clip 40.

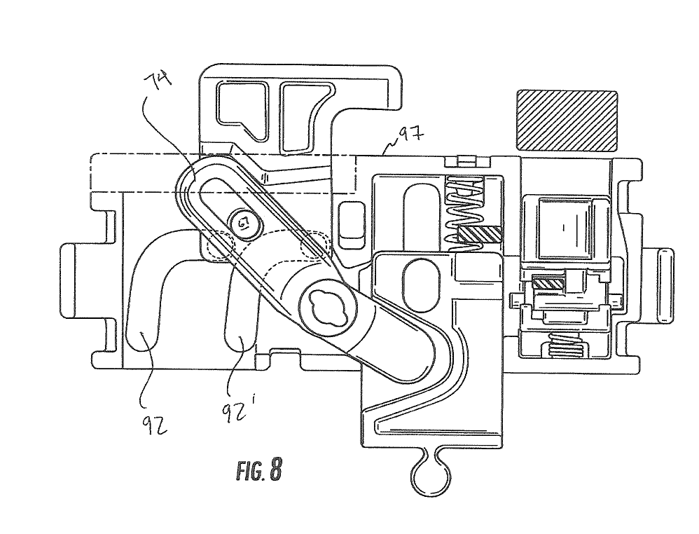

In a further embodiment, the housing includes base 90 and lid 93, where base 90 is in communication with hook 68 and where base 90 includes L-shaped channel 92 having generally vertical section 94, generally horizontal section 96, and arc section 98 connecting generally vertical section 94 with generally horizontal section 96. In some of these embodiments, hook 68 includes post 66 placed within L-shaped channel 92 for guiding a movement of hook 68 within the L-shaped channel 92. In other embodiments and shown in FIG. 8, base 90 includes second L-shaped channel 92′ for inhibiting undesired rotation of hook 68 relative to base 90 or hook 68 relative to post 66. In these embodiments, hook 68 includes second post 66′ to be placed in second L-shaped channel 92′.

As shown in FIG. 4, hook 68 includes arm post 67 for connecting end 74 of rotatable arm 70 with hook 68, and where a movement of rotatable arm 70 and a movement of hook 68 is guided by L-shaped channel 91 in lid 93. It is understood that L-shaped channels 91, 92′ have all of the limitations of L-shaped channel 92. As shown, all L-shaped channels are the same geometry.

It is understood that the shape or geometry of channels 91, 92, 92′ affect the movement of hook 68, and more particularly the engagement of hook 68 within strike 20. In some embodiments, a shorter or longer vertical movement and/or a shorter or longer horizontal movement for hook 68 are achieved by a variation in a shape of channels 91, 92, 92′. In another embodiment, channels 91, 92, 92′ have a straight geometry. In other embodiments, the respective vertical sections of channels 91, 92, 92′ are set at an angle relative to the horizontal sections of channels 91, 92, 92′. The angle is acute in some cases and obtuse in other cases. In further embodiments, the number of channels for guiding hook 68 is four or more. In some of these embodiments, a plurality of channels are used. In an optional embodiment, the amount of channels used for guiding hook 68 is one or two.

As shown in FIGS. 6-8, rotatable arm 70 is driven to rotate about pivot 76 by button 30, where end 72 of rotatable arm 70 is placed within crevice 34 of button 30. As button 30 is driven in a generally downward direction (in the orientation shown in FIGS. 6-8) by spring 32, crevice 34 rotates end 72 in a generally clockwise direction about pivot 76. As a result, other end 74 also rotates in a generally clockwise direction causing arm post 67 and posts 66, 66′ to move from their respective vertical sections to horizontal sections, which results in hook 68 moving upwards from lid surface 97 before moving toward the right to engage with shoulder 22. The upward movement of hook 68 is for facilitating engagement with, and in some cases ensuring engagement with, shoulder 22. Without sufficient vertical or upward movement, hook 68 may hit side 23 of shoulder 22 and may not engage properly with shoulder 22 to lock sashes 12, 14. As shown, rotatable arm 70 transmits a generally vertical or linear movement of button 30 to a generally vertical movement of hook 68 in an opposite direction of button 30 followed by a generally horizontal movement of hook 68, or movement generally perpendicular to the linear movement of button 30.

As shown in FIGS. 1-3, closing window 8 means bringing sashes 12, 14 together. Also as shown, strike magnet 44 is located within strike 20 and is a repelling magnet because it has the same polarity as magnet 80, and wherein placing strike magnet 44 proximate to magnet 80 causes magnet 80 to move away from strike magnet 44. Therefore, as sashes 12, 14 are brought together, strike magnet 44 repels magnet 80 and this the movement of magnet 80 causes trigger 50 to likewise move and such movement of trigger 50, as described above, causes hook 68 to engage with shoulder 22. As described, lock 10 automatically locks window 8 once sashes 12, 14 are brought together and no other user invention is needed. In addition, no contact is needed between lock 10 and strike 20 in order for lock 10 to automatically operate and for hook 68 to automatically engage strike and secure sashes 12, 14 together.

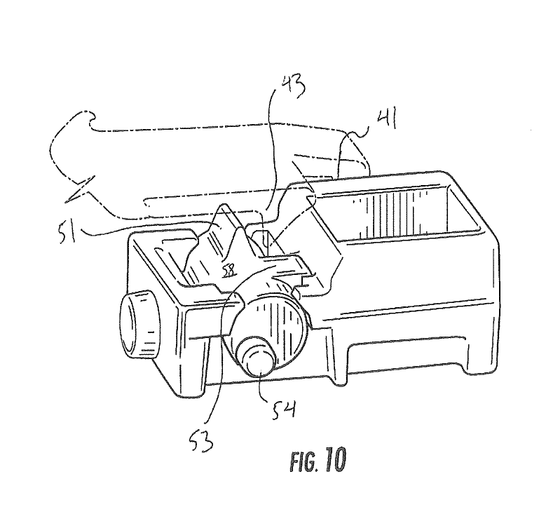

Once trigger 50 is in a downward motion, it will engage with second spring clip flange 43 of spring clip 40 to release the hold of spring clip 40 on button 30 and allow spring 32 to bias button 30 downwardly from the unlocked position to the locked position. As shown more particularly in FIG. 10, trigger 50 includes first protrusion 51 and second protrusion 53, where first protrusion 51 pushes second spring clip flange 43 and spring clip 40 away from surface 58 of trigger 50 and away from button 30. This pushing away releases the hold of spring clip flange 41 upon button flange 31.

Second protrusion 53 is placed adjacent to first protrusion 51 but second protrusion 53 does not come in contact with spring clip 40. Instead, second protrusion 53 contacts upper wall 62 of trigger housing 60, which inhibits first protrusion 51 from rotating away from, or in a clockwise direction shown in FIG. 10, second spring clip flange 43 (also see FIG. 4). As shown, second protrusion 53 extends from surface 58 in a different direction than first protrusion 51. In some embodiments, second protrusion 53 extends in a radial direction that is different from a radial direction of first protrusion 51. In other embodiments, second protrusion 53 extends tangentially from surface 58 in a different direction than a tangentially extending first protrusion 51.

To unlock window 8, the user engages push plate 18 by pushing upon it and this causes button 30 to be pushed upwards (in the orientation shown in FIG. 6), toward the unlocked position and compressing spring 32. Continued upward movement results in spring clip 40 re-engaging with button 30 to hold button 30 in the unlocked position. Because end 74 of rotatable arm 70 is maintained within crevice 34, arm 70 rotates in a generally counterclockwise rotation (in the orientation shown in FIGS. 6-8), resulting in hook 68 disengaging from shoulder 22 and post 66 moving to from generally horizontal section 96 to generally vertical section 94, wherein hook 68 is flush with or below surface 97 of lid 93. In this position, sashes 12, 14 are unlocked from one another and may be moved apart resulting in window 8 being opened.

Since sashes 12, 14 are spaced apart and window 8 may be open, repelling magnet 44 and magnet 80 are no longer in close proximity to one another resulting in second spring 52 biasing trigger 50 to the unlocked position without resistance from repelling magnet 44 inhibiting magnet 80 (and therefore trigger 50 due to magnet 80 being connected or attached to trigger 50) from moving in this direction.

As shown, as trigger 50 moves toward the unlocked position (the position shown in FIGS. 6 and 9), first protrusion 51 comes in contact with second spring clip flange 43 and rotates away from a movement of trigger 50, or in a counterclockwise direction shown in FIG. 10, as trigger 50 continues toward the unlocked position. After passing under second spring clip flange 43, lugs 54, 54′ come in contact with reset walls 54b, 54b′ (see FIG. 4), which causes trigger 50 to rotate until first protrusion 51 is in a position to re-engage with spring clip 40. In some of these embodiments, the rotation due to lugs 54, 54′ coming in contact with reset walls 54b, 54b′ continues until second protrusion 53 comes in contact with upper wall 62.

In another embodiment, as trigger 50 moves toward the unlocked position (the position shown in FIGS. 6 and 9), trigger 50 rotates about lug 54 that is attached to and extends from trigger 50 in an axial direction. As shown, lug 54 has a longitudinal axis spaced apart from a longitudinal axis of trigger 50 and there are two lugs 54, 54′. While moving toward the unlocked position, first protrusion 51 hits or contacts second spring clip flange 43 and rotates in a reverse counterclockwise direction (orientation in FIG. 10) as trigger 50 continues moving toward the unlocked position. After passing under second spring clip flange 43, due to the continued upward movement of trigger 50, trigger 50 continues its clockwise rotation about lugs 54, 54′ until second protrusion 53 makes contact with upper wall 62, whereupon rotation will stop and first protrusion 51 will be in a position to re-engage with spring clip 40 to release button 30, or in other words trigger 50 will be in the same or similar position shown in FIGS. 6 and 9.

As shown, a movement of trigger 50 from the locked position to the unlocked position is independent of a movement of button 30. In some embodiments, the movement of trigger 50 from the locked position to the unlocked position is independent of a movement of button from the locked position to the unlocked position.

However, this independence is not in the unlocked to the locked position. As described above, a movement of trigger 50 from the unlocked position to the locked position actuates a movement of button from the unlocked position to the locked position.

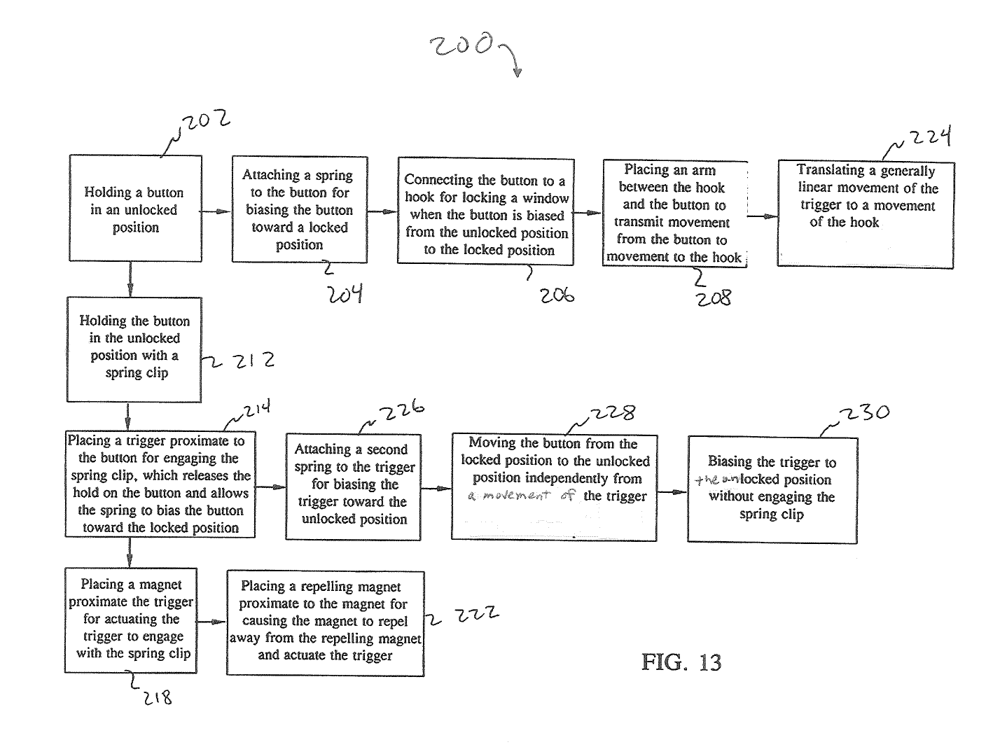

In another aspect of the invention, FIG. 13 depicts method 200 for providing lock 10 shown in FIGS. 1-12, comprising the steps of holding 202 a button in an unlocked position; attaching 204 a spring to the button for biasing the button toward a locked position; connecting 206 the button to a hook for locking a window when the button is biased from the unlocked position to the locked position; and placing 208 an arm between the hook and the button to transmit movement from the button to movement to the hook.

It is understood that attaching 104 a spring to the button includes the step of placing the spring adjacent to the button and that the spring need not be fixed to the button for the lock to function properly. In another embodiment, the spring is attached or connected to the button.

In other embodiments, method 200 includes the step of holding 212 the button in the unlocked position with a spring clip. In some of these embodiments, method 200 includes the step of placing 214 a trigger proximate to the button for engaging the spring clip, which releases the hold on the button and allows the spring to bias the button toward the locked position. In a further embodiment, method 200 places 218 a magnet proximate the trigger for actuating the trigger to engage with the spring clip.

In another embodiment, method 200 places 222 a repelling magnet proximate to the magnet for causing the magnet to repel away from the repelling magnet and actuate the trigger.

In yet another embodiment, method 200 further comprises the step of translating 224 a generally linear movement of the trigger to a movement of the hook that is generally perpendicular to the movement of the trigger.

In further embodiments, method 200 attaches 226 a second spring to the trigger for biasing the trigger toward the unlocked position.

In some embodiments, method 200 moves 228 the button from the locked position to the unlocked position independently from the step of biasing the trigger from the locked position to the unlocked position. In an optional embodiment, method 200 includes the step of biasing 230 the trigger to the unlocked position without engaging the spring clip.

What follows is a more detailed description of the operation of lock 10. For opening window 8, button 30, which is normally biased out of the housing by the use of a compression spring, is held in the inward direction by a detent clip, or spring clip 40, feature on the polymer lid or any other material. The locking hook 68 is in turn held within the lock housing by the use of a drive arm 70 that is pivoted in the lock housing and in turn driven by button 30.

When closing window 8, sashes 12, 14 are brought together and lock 10 automatically and without user intervention secures sashes 12, 14 together via hook 68. Repelling magnet 44 is housed in a strike that is mounted to the rear sash of the window. When the front sash, in which the lock mechanism is mounted, is pushed closed, the striker magnet 44 and the lock magnet 80 are aligned. In this position, the two magnets are orientated so that one of the poles (e.g. North) on the strike magnet and the same pole on the lock magnet are facing each other. This creates an opposing force. The opposing force drives the trigger mechanism (consisting of trigger housing 60, trigger 50, lock magnet 80 and compression spring 52) away from the striker 20, and toward the inside (or downward direction as shown in FIG. 9) of lock housing (lid 93 and base 90). The trigger wheel 50, mounted in the trigger housing 60, has first protrusion 91 that lifts the detent clip 40 on lid 93. This protrusion travels beyond the lifting ramp on the detent and comes to rest in a clear space behind the detent. When the clip is lifted out of the detent position in the button, the compression spring biasing the button out is allowed to drive the button to its rest position. This in turn drives the locking hook 68 out and into the strike.

To open window 8, the button is pushed into the lock housing and in turn the locking hook is pulled out of the strike and into the lock housing. The detent clip 40 on lid 93 engages button 30 and holds the button against the force of the compression spring 32. The detent is allowed to happen because in this state, the trigger mechanism is still in clear space behind the detent clip due to the opposing magnetic forces. In this state the window is free to be opened.

Once the front sash is lifted away from the strike, the trigger mechanism resets to a state that will allow the trigger wheel protrusion to lift the polymer detent once again if the two magnets in the system are again aligned. Because the opposing force from the strike magnet is no longer in play, the trigger mechanism return spring is now allowed to push the trigger mechanism back to the primed position. While the trigger slide is moving towards the primed position, the trigger wheel rotates so that the protrusion travels under the detent clip without lifting the detent clip. When the trigger slide nears its home/primed position, lugs on the trigger wheel hit walls on the lock housing and rotate the trigger wheel back to its primed position.

Features of lock 10 include a two motion locking hook travel, wherein the locking hook is driven by the drive arm via the button, it first moves in the outwards direction, and in the second part of the travel, it moves horizontally so that the hook part of the locking hook is allowed to travel firstly into the strike and then horizontally to engage the hook behind the strike.

Another feature of lock 10 is an anti-picking device—this reduces the chance of forcing the bolt out of the striker when the lock is in the fired position. There are three tracks in which the locking hook travels. Two, in base 90, determine the motion of the locking hook, and a third in the polymer lid 93 that prevents the locking hook from racking. The inwards track has an additional portion that allows the corresponding boss on the locking hook to move into a ‘locked out’ position if the hook is manipulated during a forced entry.

A further feature is the flexibility to open window 8 in any one of three ways: direct push of the button, top and bottom mounted feature on the button to drive button from the top or bottom of the lock, and a pivot feature built into the drive arm pivot 76.

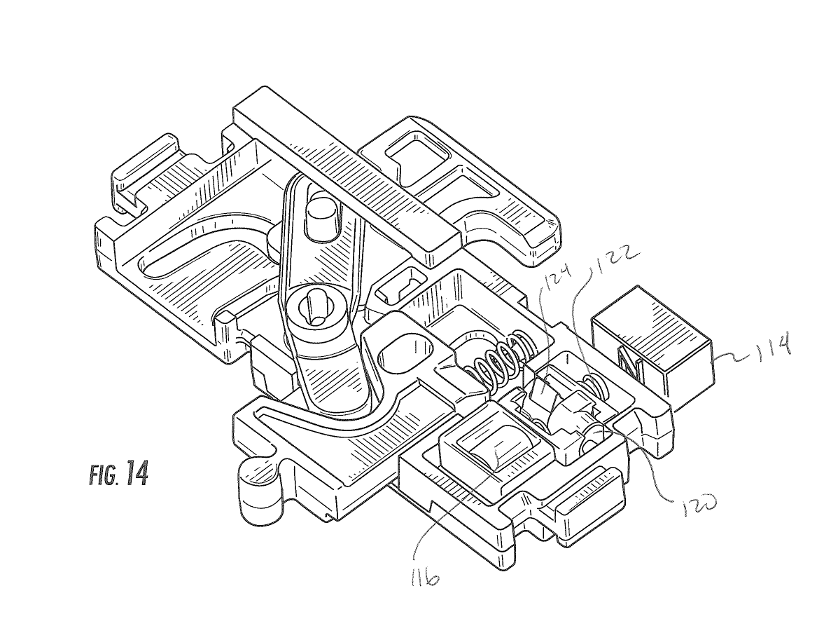

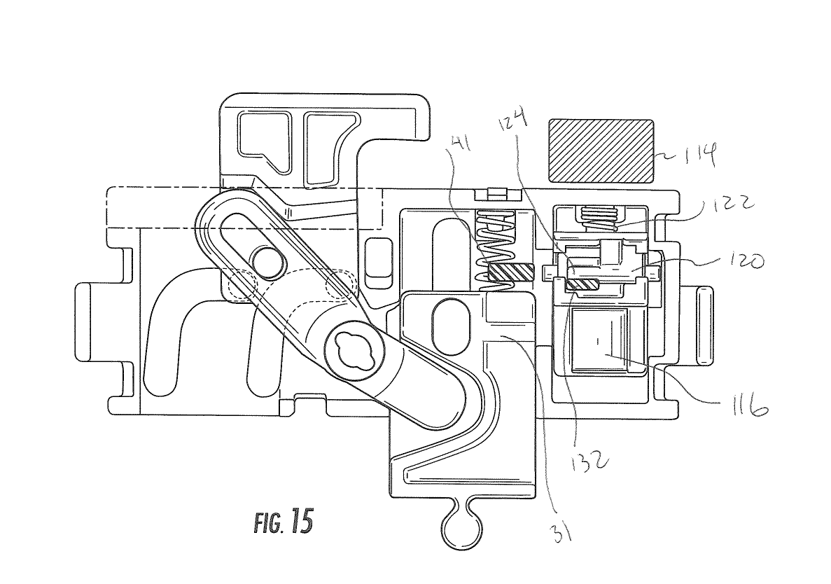

In another aspect of the invention shown in FIGS. 14-18, strike magnet 44 is not a repelling magnet but is an attracting magnet because it attracts magnet 80 toward attracting magnet 44. As shown, trigger 120 and second spring 122 switched positions with each other relative to the positions shown in FIGS. 1-13.

Because attracting magnet 114 attracts magnet 116 within trigger 120, magnet 116 and trigger 120 tend to move toward attracting magnet 114 when both magnets are placed proximate to each other, which is when sashes 12, 14 are brought together or window 8 is closed.

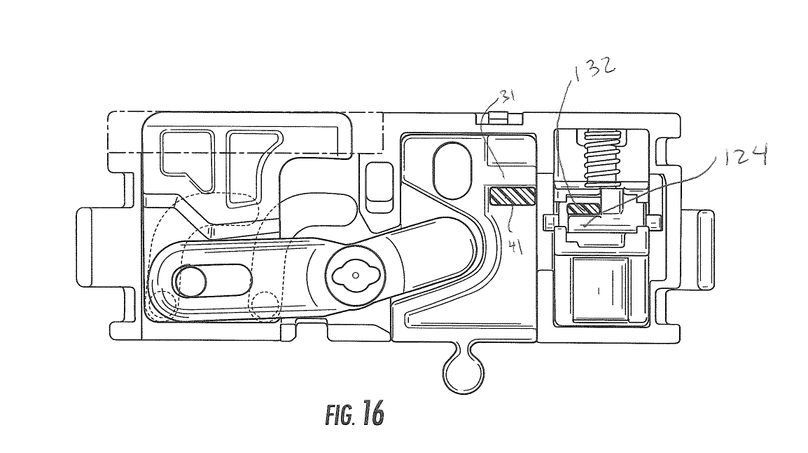

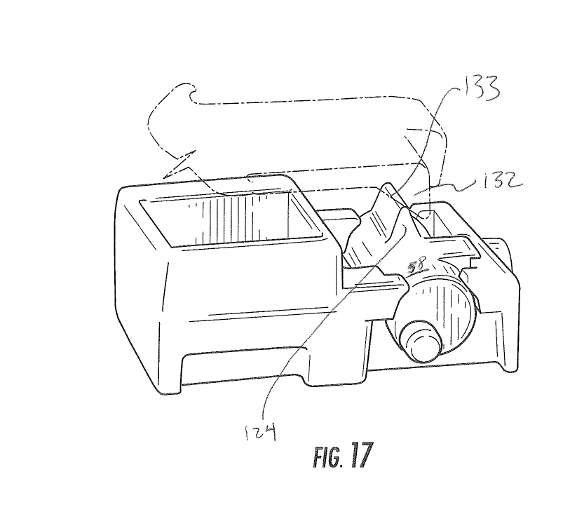

When magnet 114 moves upward in the orientation shown in FIGS. 15-16, first protrusion 124 pushes spring clip 40 away from button 30, which releases button 30 from the unlocked position and allows spring 32 to bias button 30 as stated above under FIGS. 1-13.

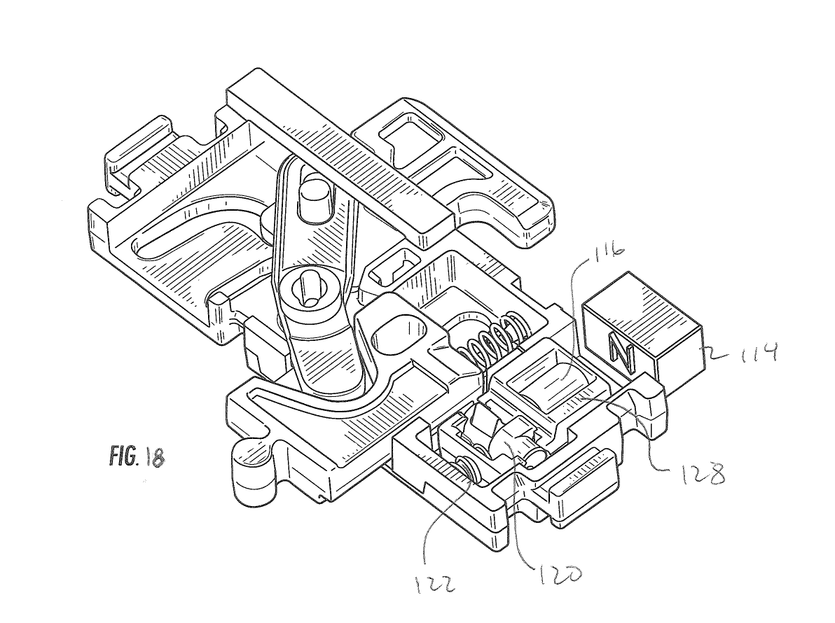

As shown in FIG. 17, second spring clip flange 132 varies from second spring clip flange 43 in that ramped surface 133 faces an opposite direction in FIG. 17 than in FIG. 10. This is because trigger 120 and first protrusion 124 of FIGS. 14-17 are moving upward toward attracting magnet 114, whereas trigger 50 and first protrusion 51 of FIGS. 1-13 are moving downward away from repelling magnet 44. However, the purpose of trigger 120 is to engage with spring clip 40 to release its hold on button 30, and therefore any direction of travel for trigger 120 is acceptable and within the scope and spirit of lock 10.

As shown in FIG. 16, lock 10 is in an unlocked position where hook 68 is retracted within the housing (base 90 and lid 93). Second spring clip flange 132 is located above first protrusion 124 and, similar to FIGS. 1-13, spring clip flange 41 is holding button flange 31 and button 30 in the unlocked position.

When sashes 12, 14 are brought together, it causes magnet 116 to move upward toward the position shown in FIG. 15, which is above second spring clip flange 132. In the process, first protrusion 124 engages with ramped surface 133 which in turn causes spring clip 40 to move away from surface 58 of trigger 120 to release button 30. Once passing second spring clip flange 132 due to magnet 116 moving toward attracting magnet 114, it results in the position shown in FIG. 15.

Similar to the use of second spring 32, second spring 122 in FIGS. 14-17 return first protrusion 124 and trigger 120 to the unlocked position when attracting magnet 114 and magnet 116 are moved away from each other, such as when window 8 is open. First protrusion 124 passes under second spring clip flange 132 and rotates into a position to re-engage with second spring clip flange 132 in the same manner as described herein. For attracting magnet 114 to attract magnet 116, both magnets have opposite polarity to one another. Therefore, one magnet has a north polarity and the other magnet has a south polarity.

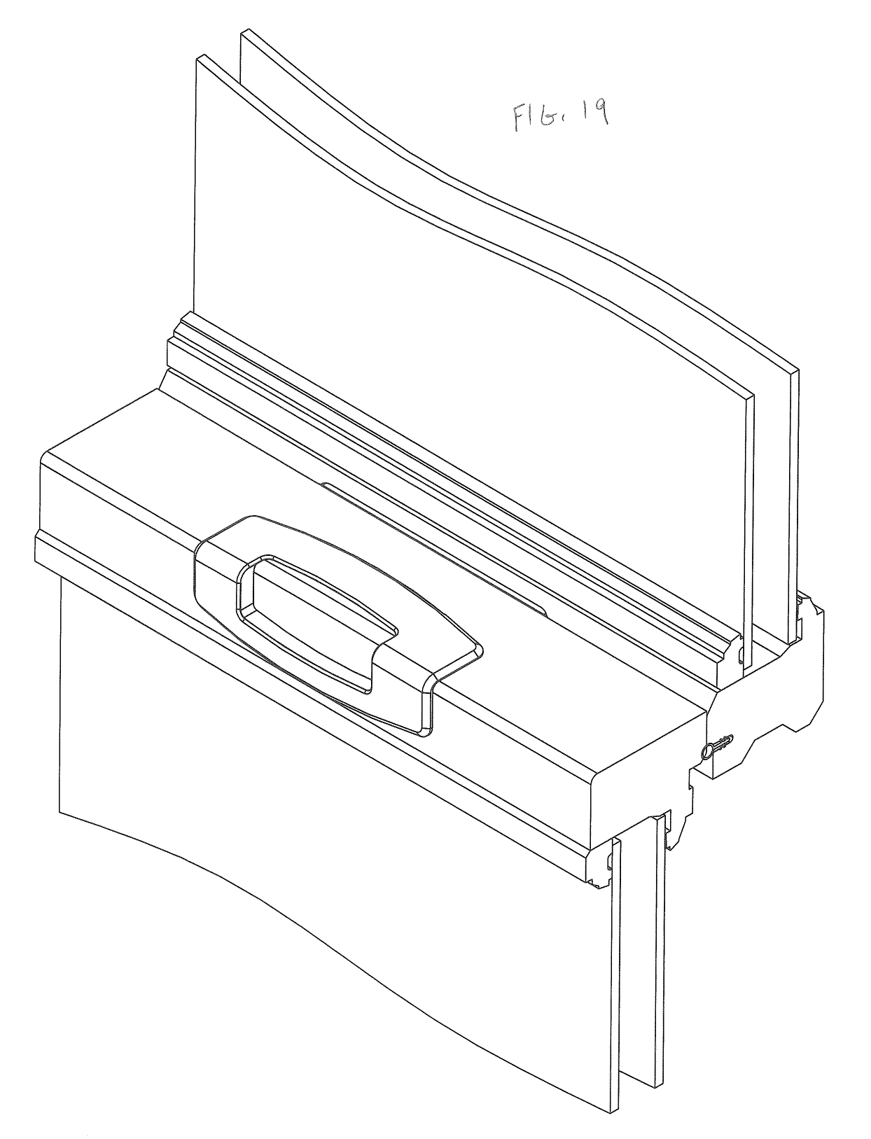

FIG. 18 depicts a variation of lock 10 using attracting magnet 114 where trigger 120, second spring 122, and trigger housing 128 have the same relation to the rest of the components of lock 10 as described in FIGS. 1-13. In this variation, second spring 122 is a tension spring (FIGS. 1-17 describe second spring as a compression spring) that biases trigger 120 toward the locked position or away from attracting magnet 114.

Therefore, when sashes 12, 14 are brought together, trigger 120 and magnet 116 are moved toward attracting magnet 114, and in the process engage with second spring clip flange 132 and release button 30. When window 8 is open, attracting magnet 114 is moved away from magnet 116 and tension spring 122 biases trigger 120 toward the unlocked position, or downward in the orientation shown in FIG. 18.

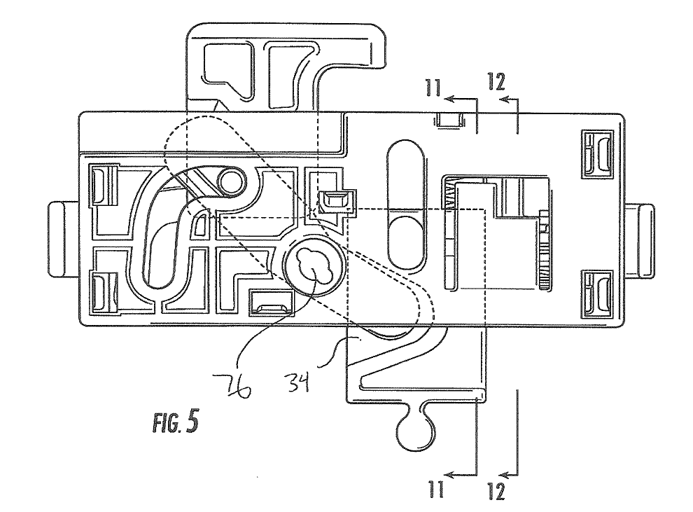

FIG. 19 depicts push plate 18 being used as an indicator for indicating when lock 10 is in a locked or unlocked position. To open window 8 after lock 10 has locked the two sashes 12, 14 together, and wherein hook 68 is engaged with strike 20 and shoulder 22, a user may push upon push plate 18. Pushing upon push pate 18 results in a push upon button 30 (in the upward direction when lock 10 is in the orientation shown in FIGS. 5-9). When button 30 is pushed in this upward direction, hook 68 is moved to the unlocked position. Therefore, button 30 remaining in the upward direction means hook 68 and lock 10 is in the unlocked position.

Attaching push plate 18 to button 30, whether directly or indirectly, gives a visual indication to the user as to when lock 10 is locked or unlocked because if button 30 is in the unlocked position (FIG. 6), push plate 18 is pushed in as shown in FIG. 19. If button 30 is in the locked position (downward as shown in FIG. 5), push plate 18 will not pushed in.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A lock for a window, comprising:
a button having a spring for biasing said button to move from an unlocked position to a locked position;
a spring clip in contact with said button for holding said button in the unlocked position;
a trigger for engaging with said spring clip to release said button and allow said spring to move said button toward the locked position;
a hook for moving from an unlocked position to a locked position in correspondence with said button moving from the unlocked position to the locked position; and
an arm with one end attached to said button and another end attached to said hook, said arm for transmitting a movement of said button to a movement of said hook.

2. The lock according to claim 1, wherein said trigger includes a second spring to move said trigger from a locked position to an unlocked position, said second spring being separate from said spring.

3. The lock according to claim 1, further comprising a magnet in contact with said trigger for actuating said trigger to engage with said spring clip.

4. The lock according to claim 1, further comprising a housing in communication with said hook, said housing including a channel; and
said hook includes a post being placed within said channel for guiding a movement of said hook within said channel.

5. The lock according to claim 1, further comprising a strike magnet in communication with said magnet for moving said magnet when said strike magnet is placed proximate to said magnet.

6. The lock according to claim 1, wherein said trigger includes a first protrusion and a second protrusion;
said first protrusion is positioned proximate to said spring clip for engaging with said spring clip to release said button; and
said second protrusion extending from a surface of said trigger in a different direction than said first protrusion.

7. The lock according to claim 1, further comprising a lug attached to said trigger for positioning said first protrusion for engaging with said spring clip.

8. The lock according to claim 1, wherein said arm transmits a generally linear movement of said trigger to a movement of said hook.

9. The lock according to claim 1, wherein a movement of said trigger from the locked position to the unlocked position is independent of a movement of said button from the locked position to the unlocked position; and
wherein a movement of said trigger from the unlocked position to the locked position actuates a movement of said button from the unlocked position to the locked position.

10. A method of providing a lock, comprising the steps of:
holding a button in an unlocked position;
placing a spring adjacent to the button for biasing the button toward a locked position;
connecting the button to a hook for locking a window when the button is biased from the unlocked position to the locked position; and
placing an arm between the hook and the button to transmit movement from the button to movement to the hook.

11. The method according to claim 10, further comprising the step of holding the button in the unlocked position with a spring clip.

12. The method according to claim 11, further comprising the step of placing a trigger proximate to the button for engaging the spring clip, which releases the hold on the button and allows the spring to bias the button toward the locked position.

13. The method according to claim 12, further comprising the step of placing a magnet proximate the trigger for actuating the trigger to engage with the spring clip.

14. The method according to claim 13, further comprising the step of placing a strike magnet proximate to the magnet for moving the magnet and actuating the trigger.

15. The method according to claim 12, further comprising the step of translating a generally linear movement of the trigger to a movement of the hook.

16. The method according to claim 12, further comprising the step of attaching a second spring to the trigger for biasing the trigger toward the unlocked position.

17. The method according to claim 12, further comprising the step of moving the button from the locked position to the unlocked position independently from a movement of the trigger.

18. The method according to claim 12, further comprising the step of biasing the trigger to the unlocked position without engaging the spring clip.

19. The method according to claim 10, further comprising the step of indicating whether or not the hook is in a locked position or in an unlocked position.

20. A lock for a window, comprising:
a button having a spring for biasing said button to move from an unlocked position to a locked position;
a spring clip in contact with said button for holding said button in the unlocked position;
a trigger for engaging with said spring clip to release said button and allow said spring to move said button toward the locked position;
a hook for moving from an unlocked position to a locked position in correspondence with said button moving from the unlocked position to the locked position;
a housing having at least one channel for guiding the movement of the hook;
a magnet in contact with said trigger for actuating said trigger to engage with said spring clip; and
a strike magnet in communication with said magnet for moving said magnet when said strike magnet is placed proximate to said magnet.
